(19) United States
(12) Patent Application Publication
(10) Pub. No.: US 2002/0005334 A1
(43) Pub. Date: Jan. 17, 2002

(54) Conveying device with plurality of running motors

(75) Inventors: Tomoharu Matsumoto, Inuyama-shi (JP); Satoshi Kamide, Kani-shi (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Murata Kikai Kabushiki Kaisha, Kyoto-shi (JP)

(21) Appl. No.: 09/885,969

(22) Filed: Jun. 22, 2001

(30) Foreign Application Priority Data
Jul. 12, 2000 (JP) 2000-211318

(51) Int. Cl. B65G 17/20

(52) U.S. Cl. 198/678.1

(57) ABSTRACT

A top and a bottom running motors 16, 18 are provided in a stacker crane 4, and a running speed pattern is set such that a motor subjected to heavier loads from an elevating and lowering table 8 outputs a predetermined torque. The present invention provides such control that the heavier-load-side running motor outputs the predetermined torque, so that the performance of the running motors can be maximized for running with a high acceleration and deceleration.

### FIELD OF THE INVENTION

The present invention relates to control of running of a conveying device with a plurality of running motors.

### BACKGROUND OF THE INVENTION

The applicant has been developing a stacker crane including running motors at its top and bottom and which can run at a high speed. In such a stacker crane, when an elevating and lowering table is elevated or lowered along a mast, loads on the top and bottom running motors vary.

It is an object of the present invention to control a plurality of running motors taking into consideration variations in loads on the running motors caused by movement of a support section for a conveyed article.

It is an additional object of the present invention to reduce the amount of time for running by causing a stacker crane with the running motors at its top and bottom to run with a high acceleration and deceleration.

It is an additional object of the present invention to enable the stacker crane to run with a high acceleration and deceleration by positively utilizing the movement of the support section so that a time zone when the running motor is accelerated or decelerated overlaps easily a time zone when the support section is located in a area where the loads are balanced between the plurality of running motors.

### SUMMARY OF THE INVENTION

The present invention provides a conveying device comprising at least two running motors disposed at an interval and a motor for moving a support section for a conveyed article in a direction substantially at a right angle to a running direction, the conveying device being characterized by further comprising control means for controlling the running motors so that an output torque from a heavier-load-side running motor meets a predetermined condition for loads distributed to the at least two running motors depending on a position of the support section in the right-angle direction.

The substantially right-angle direction refers to, for example, a substantially vertical direction in the case of a stacker crane, and refers to a lateral direction with respect to a running direction in the case of an overhead traveling crane, that is, a direction substantially at a right angle to the running direction in a horizontal surface. The magnitude of loads on each running motor means the ratio of the loads on the running motor to a performance value of the running motor such as its rated output torque, that is, the relative value of the level of the loads as determined with reference to the performance of the running motor. Further, the predetermined condition to be met by the output torque from the running motor is, for example, the ratio of the output torque to the rated output torque. Moreover, if the ratio of the loads to the performance of the motor or the like is balanced between the two running motors, it is said that the loads are balanced. If the ratio is not balanced between these running motors, it is said that the loads are unbalanced.

Preferably, the conveying device is a stacker crane comprising the running motors at a top and a bottom thereof, and the control means controls the top and bottom running motors so that the heavier-load-side running motor provides an output torque of a predetermined value.

Further, preferably, the control means includes means for providing such control that the support section is moved from a position where the loads are balanced between the running motors to a position where the loads are unbalanced therebetween and that the movement of the support section is delayed when the amount of time for the movement in the right-angle direction is equal to or smaller than the amount of time for the running. The delay means the delay of the start of the movement or a decrease in acceleration or deceleration compared to normal operations.

The present invention focuses on variations in the distribution of the loads to the running motors depending on the position of the support section. For example, with a pair of running motors, when the support section approaches one of the motors, the loads on that motor increase, whereas the loads on the opposite motor decrease. Thus, the present invention controls at least two running motors so that the output torque from the heavier-load-side running motor meets the predetermined condition.

Consequently, the present invention provides various effects. If, for example, the device is to run at a high speed, and if the predetermined condition for the output torque is determined so that a maximum output torque can be obtained while avoiding overloads, the device can run with a maximum acceleration and deceleration without overloading the running motors. Thus, the conveying device operates more efficiently. If the object is to avoid overloads on the running motors, the predetermined condition for the output torque may be selected so as to avoid overloading the motors. The present invention provides control in response to variations in loads on the running motors, thus obtaining various effects such as the capability of running with a high acceleration and deceleration and prevention of overloads.

The present invention is applied to a stacker crane, which must particularly run at a high speed, and control is provided such that the heavier-load-side running motor provides an output torque of the predetermined value. Consequently, the device can be run with the maximum acceleration and deceleration without overloading the heavier-load-side motor, thus reducing the running time.

In the present invention, if the support section moves from the position where the loads are balanced between the motors to the position where the loads are unbalanced therebetween, and if the estimated duration of the movement of the support section is equal to or shorter than that of the running, then the movement of the support section is delayed to extend a range in which the running motors can be controlled with a high acceleration and deceleration, thereby further reducing the running time.

### BRIEF DESCRIPTION OF THE DRAWINGS

FIG. 1 is a side view showing an embodiment of a vertical running driving stacker crane.

FIG. 2 is a block diagram showing a section for generating speed patterns according to the embodiment.

FIG. 3 is a flow chart showing an algorithm for generating speed patterns according to the embodiment.

FIG. 4 is a view showing an example of a running speed pattern and an elevating and lowering speed pattern for a case in which an elevating and lowering table elevates or lowers from a state where its loads are balanced between a top and a bottom running motors to a state where the loads are unbalanced therebetween.

FIG. 5 is a view showing a reference table containing speed patterns.

FIG. 6 is a front view showing a variation of an overhead traveling crane.

### DETAILED DESCRIPTION OF THE PREFERRED EMBODIMENTS

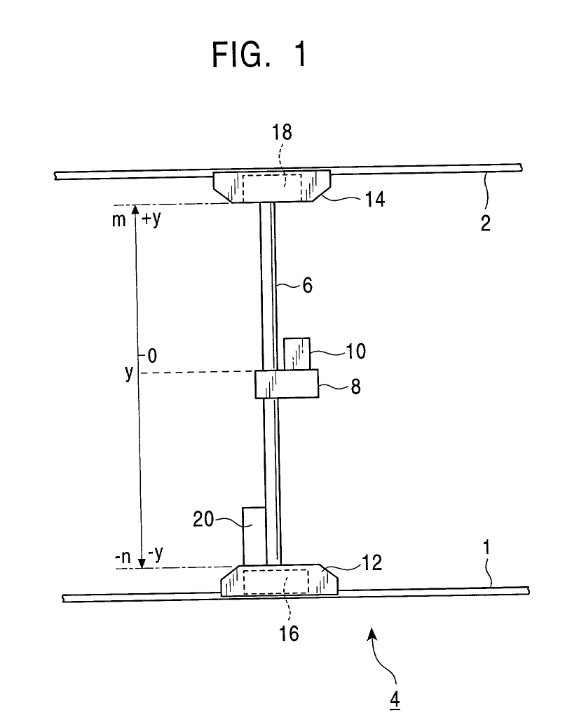

FIGS. 1 to 6 shows an embodiment of the present invention and variations thereof. Running rails 1 and 2 are disposed in an automatic warehouse, in a stocker in a semiconductor plant, or in another site. The running rail 1 is installed on the ground, while the running rail 2 is installed on the ceiling. 4 is a stacker crane and 6 is a mast. A conveyed article 10 is loaded on an elevating and lowering table 8 that elevates and lowers along the mast 6, and is then conveyed from one shelf to another in the automatic warehouse, the stocker, or the like, or from a station to a shelf. 12 is a ground cart and 14 is a ceiling cart, respectively, which run along the running rails 1, 2, respectively. 16, 18 are running motors for the respective carts 12, 14. Further, 20 is an elevating and lowering motor for elevating and lowering the elevating and lowering table 8 along the mast 6.

The distribution of loads to the running motors 16, 18 will be described.

The ground running motor 16 is responsible for accelerating and decelerating the ground cart 12, the elevating and lowering motor 20 and a portion of the mast 6 which is closer to the ground. The ceiling running motor 18 is responsible for accelerating and decelerating the ground cart 14 and a portion of the mast 6 which is closer to the ceiling. Which running motor is responsible for the elevating and lowering table 8 and the article 10 thereon depends on the position of the elevating and lowering table 8. If, for example, the elevating and lowering table 8 approaches the ground cart 12, the loads on the ground cart 12 increase, and if the elevating and lowering table 8 approaches the ceiling cart 14, the loads on the ceiling running motor 18 increase.

In the embodiment, the object is to drive the running motors 16, 18 so as to provide an output torque of a predetermined ratio or less to a rated output torque having a predetermined value. Furthermore, when output torques from the running motors 16, 18 are at the same ratio to the predetermined value, it is said that the loads are balanced. A point where the loads are balanced may approximate an intermediate point between the ground cart 12 and the ceiling cart 14, but in fact, it does not necessarily need to be the intermediate point.

For example, the rated output torque for the ground running motor 16 may be higher than that for the ceiling running motor 18, and the mast 6 may be rigidly coupled to the ground cart 12, whereas it may be elastically coupled to the ceiling cart 14 via an appropriate spring or damper, or the like. This is to avoid overloads on the couplings between the mast 6 and the carts 12, 14 if there is a slight difference in speed between the ground cart 12 and the ceiling cart 14. Thus, the rated output torques for the running motors 16, 18 are not the same and the carts 12, 14 are attached to the mast 6 in different manners, so that the loads are not always balanced at the intermediate location between the ground cart 12 and the ceiling cart 14. As shown in FIG. 1, the height of the top surface of the elevating and lowering table 8 is represented by a variable (y) that is zero at a point where the loads are balanced between the top and bottom running motors 16, 18. The upper limit of the variable (y) is defined as (m), and its lower limit is defined as (−n).

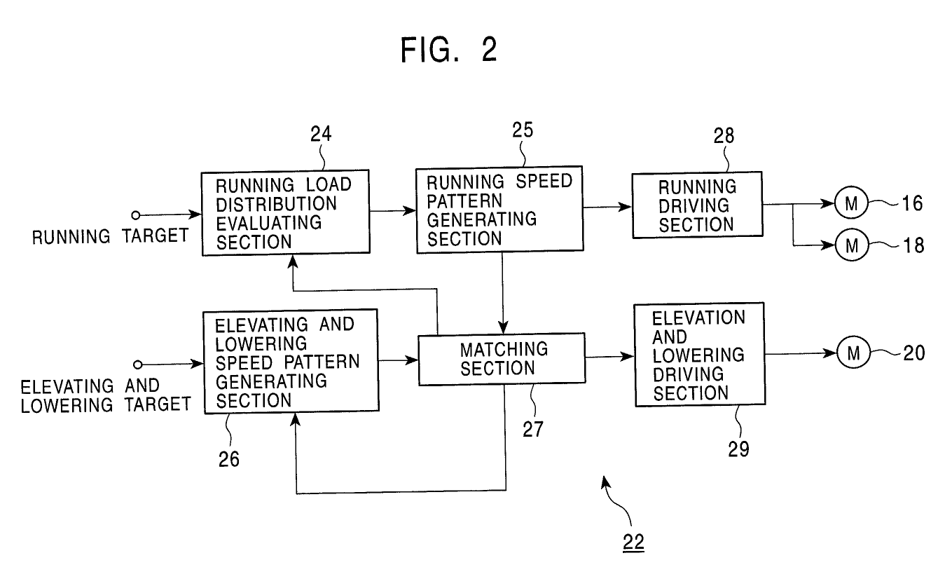

FIG. 2 shows a control section 22 for the running motors 16, 18 and the elevating and lowering motor 20. The control section 22 may be provided on the stacker crane or separately therefrom. A running destination is input to a control system for the running motors, and a running load distribution evaluating section 24 evaluates how loads are distributed to the top and bottom running motors 16, 18, to determine the loads on the running motors 16, 18. A running speed pattern generating section 25 generates a running speed pattern such that a running motor subjected to relatively heavy loads operates to provide a predetermined output torque of a predetermined ratio to the rated output torque. An elevating and lowering speed pattern generating section 26 receives the input of an elevating or lowering destination to generate an elevating or lowering speed pattern from the current position of the elevating and lowering table 8 to the destination.

A matching section 27 compares the generated elevating and lowering speed pattern with the generated running speed pattern to delay the start of the elevation or lowering of the elevating and lowering table 8 when, for example, the duration of the running is longer than that of the elevation or lowering and when the elevating and lowering table 8 moves from a position where the loads are balanced between the top and bottom running motors to a position where the loads are unbalanced. On contrary, the start of the running is delayed when the duration of the elevation or lowering is longer than that of the running and when the elevating and lowering table 8 moves from a position where the loads are unbalanced to a position where the loads are balanced. The comparison between the running speed pattern, and the elevating and lowering speed pattern as executed by the matching section 27 enables the height position of the elevating and lowering table 8 to be substantially determined at each point of running, and on the basis of this height position, the distribution of running loads is reevaluated during the running process to regenerate a running speed pattern. Further, an elevating and lowering speed pattern is regenerated so as to correspond to the delay of the start of elevation or lowering. In this manner, the operation of generating a running speed pattern and an elevating and lowering speed pattern and matching them is repeated. Once these patterns have reached a desired accuracy, in other words, once the generated speed patterns have substantially converged to the extent that the estimated running time can no longer be reduced in spite of the repeated process, the generated speed patterns are determined as final ones, and the motors 16˜20 are controlled in addition to a running driving section 28 and an elevating and lowering driving section 29.

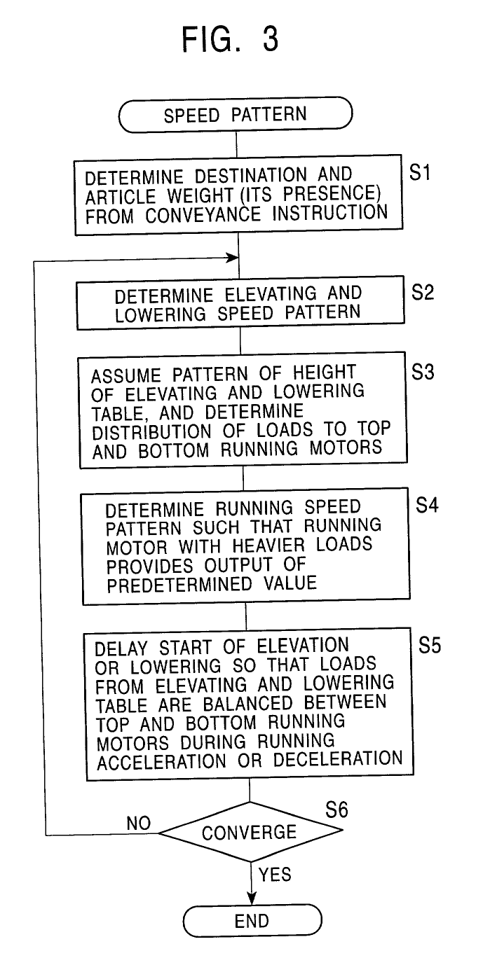

FIG. 3 shows an algorithm for generating a running speed pattern and an elevating and lowering speed pattern. The stacker crane receives a conveyance instruction for conveying an article from one point to another. The control section disintegrates this instruction into two parts, that is, the operation of running from the current position to a conveyance start point without any load and elevating or lowering to receive the article and the operation of running/elevating or lowering, after receiving the article, to the destination and delivering the article. The weight of the article may be evaluated in terms of the presence of the article or may be evaluated in terms of a large number of levels by describing it in the conveyance instruction (step 1). Subsequently, the elevating and lowering speed pattern generating section 26 in FIG. 2 generates an elevating and lowering speed pattern from the current position to the destination (step 2). Further, the running load distribution evaluating section 24 in FIG. 2 appropriately assumes a pattern of the height of the elevating and lowering table, and based on this pattern, determines the distribution of the loads to the running motors during a running process (step 3).

For example, it is assumed that the height of the elevating and lowering table is initially fixed at intermediate coordinates between the height of the current position and the height of the destination. Moreover, after the matching, the height of the evaluating and lowering table is determined relative to the time based on the evaluating and lowering speed pattern of the elevating and lowering table and taking into account the delay of the start of the operation of the elevating and lowering table, thereby determining the loads on the top and bottom running motors at each point of time.

The running speed pattern generating section 25 in FIG. 2 generates a running speed pattern such that a running motor subjected to relatively heavy loads provides an output torque of a predetermined value such as a predetermined ratio to the rated output torque (step 4). In fact, the distribution of the loads to the running motor varies with the elevation or lowering of the elevating and lowering table, but the variations in the position of the elevating and lowering table are taken into consideration after the matching. During the subsequent acceleration or deceleration, the loads from the elevating and lowering table is preferably substantially balanced between the top and bottom running motors. Thus, if the duration of the elevation or lowering is shorter than that of the running by a predetermined value or more, and if the loads move vertically from a position where they are balanced to a position where they are unbalanced, the start of the elevation or lowering is delayed (step 5). Although not shown in the drawings, if the duration of the running is shorter than that of the elevation or lowering by the predetermined value or more, and if the loads move vertically from a position where they are unbalanced to a position where they are balanced, the start of the running is delayed. The process of delaying the start of the running, however, may be omitted.

Once temporary elevating and lowering speed pattern and running speed pattern have thus been obtained, the process from step 2 to step 5 is repeated on the basis of the elevating and lowering speed pattern and running speed pattern obtained, and it is checked whether or not the running time can no longer be reduced (step 6). Then, if the elevating and lowering speed pattern or the running speed pattern cannot be substantially changed in spite of the process from step 2 to step 5, the above patterns are assumed to have converged and are determined as final ones. Then, the elevating and lowering motor and the running motors are driven using these patterns.

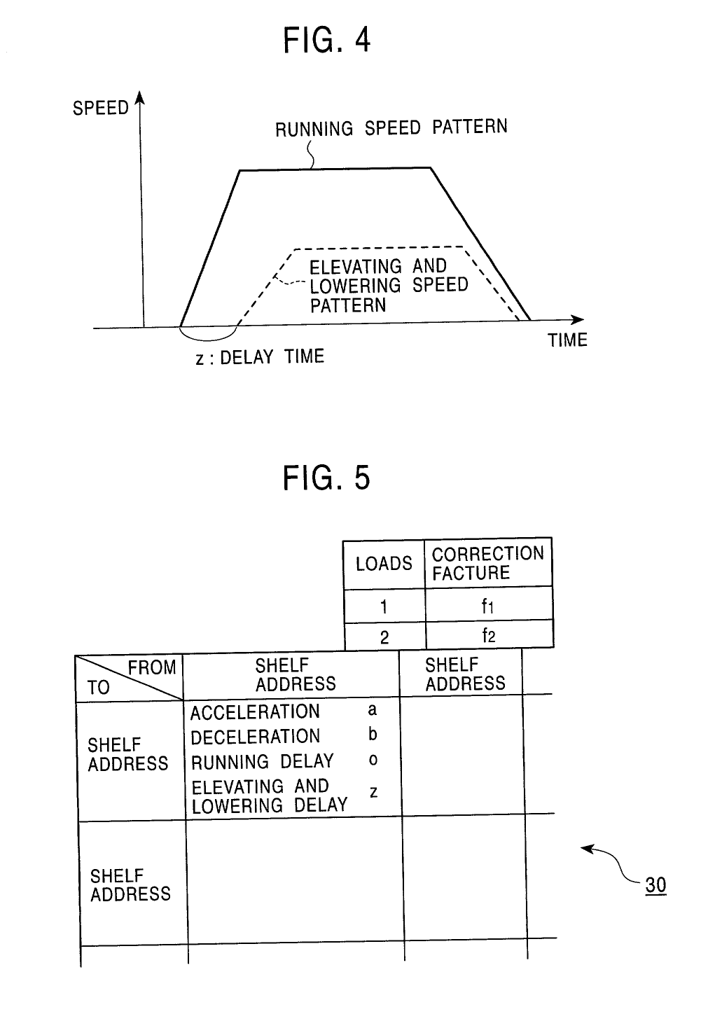

FIG. 4 shows an example of the elevating and lowering speed pattern and the running speed pattern obtained. In this example, the duration of the elevation or lowering is shorter than that of the running, and the elevating and lowering table moves from a position where the loads are balanced between the top and bottom motors to a position where the loads are unbalanced therebetween. Thus, the start of the elevation or lowering is delayed by a delay time (z). Since the movement of the elevating and lowering table is delayed at the start of the running, the elevating and lowering table remains longer at the position where the loads are balanced between the top and bottom running motors, thus making it possible to increase the acceleration of the initial running. Further, the elevating and lowering table reaches later the position where the loads are unbalanced between the top and bottom running motors, thus making it possible to relatively increase the deceleration. Moreover, the acceleration and deceleration for the running motors is controlled so that the heavier-load-side running motor provides an output torque of a predetermined value, so that a maximum acceleration and deceleration can be obtained without overloading the elevating and lowering motor. Accordingly, the device can run from the current position to the destination with the maximum acceleration and deceleration without overloading the running motors.

Although, in FIG. 3, the running speed pattern and the elevating and lowering speed pattern are determined for each conveyance instruction, these speed patterns may be determined when the stacker crane is installed and may be stored in a table so that the table can be simply referenced during actual conveyance.

FIG. 5 shows such a reference table 30. The data in the reference table 30 is described for each combination of the current shelf address or the like and a destined shelf address or the like, and contains acceleration (a) and deceleration (b) for the running motors as well as a delay time (o) for the start of running and a delay time (z) for the start of elevation or lowering. The elevating and lowering pattern is set such that with the elevation and lowering delay time (z) specified, the start of elevation or lowering is delayed by the (z) and such that an elevating and generating pattern is subsequently generated using predetermined acceleration and deceleration. Further, the acceleration (a) and the deceleration (b) are common to the vertical pair of running motors. The acceleration (a), the deceleration (b), the running delay time (o), and the elevation and lowering delay time (z) are determined for each combination of the current position and the destination by means of the process in FIG. 3, and are then stored in the reference table 30 beforehand. At this time, the presence of an article is not taken into account, and the weight of an article on the elevating and lowering table is set as loads. Correction factors (f1), (f2) and the like are described in the table for each rank of loads, and the acceleration (a) or deceleration (b) and the acceleration or deceleration of the elevating and lowering table are multiplied by the correction factor for correction based on the weight of the article. This eliminates the need to generate an elevating and lowering speed patter or a running speed patter for each conveyance instruction.

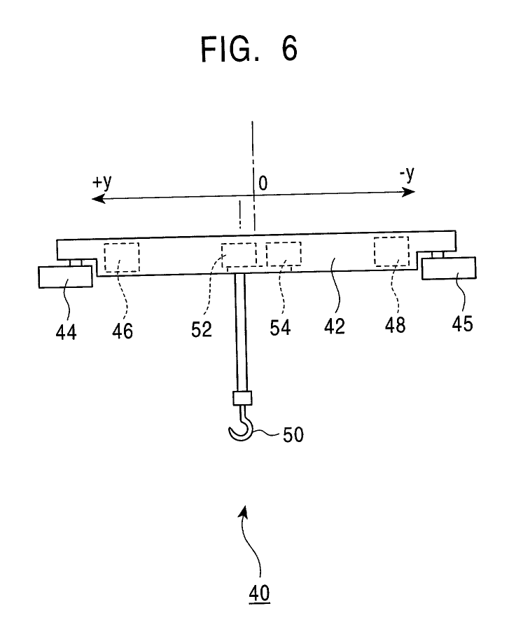

In the embodiment, a kind of repeated approximation is executed to determine an optimal running speed pattern, but the method for generating a speed pattern is arbitrary. Further, the embodiment shows the running control for the stacker crane, but the present invention is equally applicable to any device that has at least a pair of running patterns and also has variations in loads in a direction substantially at a right angle to the running direction. Such an example is shown in FIG. 6.

In FIG. 6, 40 is an overhead traveling crane, 42 is a beam thereof, and 44, 45 are a left and a right rail members. The beam 42 is run along the rail members 44 and 45 by means of running motors 46 and 48 and running wheels (not shown in the drawings). 50 is a hook, and 52 is a motor for hoisting the hook 50. 54 is a traverse-motion motor for traversing the hook 50 or the like along the beam 42. In this case, for example, the position of the hook 50 along the beam 42 is represented by a variable (y) and a point where loads are balanced between the left and right running motors 46, 48 is defined as a zero point. Then, if the traverse motion of the hook 50 executed by the traverse-motion motor 54 is considered the elevation or lowering of the elevating and lowering table in the embodiment, the embodiment is applicable to this overhead traveling crane in exactly the same manner as described above.

1. A conveying device with plurality of running motors comprising at least two running motors disposed at an interval and a motor for moving a support section for a conveyed article in a direction substantially at a right angle to a running direction, the conveying device being characterized by further comprising control means for controlling the running motors so that an output torque from a heavier-load-side running motor meets a predetermined condition for loads distributed to said at least two running motors depending on a position of the support section in said right-angle direction.

2. A conveying device with a plurality of running motors according to claim 1, characterized in that said conveying device is a stacker crane comprising the running motors at a top and a bottom thereof, and said control means is configured to control the top and bottom running motors so that the heavier-load-side running motor provides an output torque of a predetermined value.

3. A conveying device with a plurality of running motors according to claim 1 or claim 2, characterized in that said control means includes means for providing such control that said support section is moved from a position where the loads are balanced between the running motors to a position where the loads are unbalanced therebetween and that the movement of the support section is delayed when the amount of time for the movement in said right-angle direction is equal to or smaller than the amount of time for the running.
